(19) United States
(12) Patent Application Publication
(10) Pub. No.: US 2026/0140423 A1
(43) Pub. Date: May 21, 2026

(54) CAMERA MODULE AND IMAGING DEVICE

(71) Applicant: SONY SEMICONDUCTOR SOLUTIONS CORPORATION, KANAGAWA (JP)

(72) Inventors: KOHEI IMAYOSHI, KANAGAWA (JP); TAKAYUKI KUNIMITSU, KANAGAWA (JP); AKIHIRO YUKISHIGE, KANAGAWA (JP); KEIJYU KASAHARA, KANAGAWA (JP); TAKAHIRO TSURUTA, KANAGAWA (JP)

(21) Appl. No.: 19/117,410

(22) PCT Filed: Aug. 10, 2023
(86) PCT No.: PCT/JP2023/029326

§ 371 Date: Apr. 1, 2025

(30) Foreign Application Priority Data
Oct. 6, 2022 (JP) 2022-161341

(51) Int. Cl. G03B 5/04; H04N 23/54; H04N 23/55

(52) U.S. Cl. CPC G03B 5/04; H04N 23/54; H04N 23/55; G03B 2205/0023; G03B 2205/0076

(57) ABSTRACT

To downsize an imaging device that performs rotation correction. A camera module includes a lens group, a translation actuator, a rotary actuator, and a mounting substrate. In the camera module, the translation actuator translates the lens group. The rotary actuator rotates the lens group. A rigid-flexible substrate is partially deformed following rotation of the lens group. Furthermore, the translation actuator is provided on one of both surfaces of the mounting substrate, and the rigid-flexible substrate is provided on the other of the both surfaces of the mounting substrate.

### TECHNICAL FIELD

The present technology relates to a camera module. Specifically, the present technology relates to a camera module that performs camera shake correction and an imaging device.

### BACKGROUND ART

Conventionally, in a small imaging device such as a smartphone, a camera shake correction mechanism that performs correction along translation directions parallel to three axes orthogonal to each other is often used. However, in the three-axis camera shake correction mechanism, correction performance may be insufficient such as when imaging is performed while focusing on infinity. In order to solve this lack of correction performance, a rotation correction mechanism in the pitch, yaw, and roll directions is further required. Therefore, there has been proposed an optical unit in which a flexible printed circuit board that performs rotation correction is arranged next to a camera module when viewed from an optical axis direction (See, for example, Patent Document 1.).

### CITATION LIST

### Patent Document

Patent Document 1: Japanese Patent Application Laid-Open No.

### SUMMARY OF THE INVENTION

### Problems to be Solved by the Invention

In the above-described conventional technique, the correction performance is improved by adding the flexible printed circuit board. However, in the above-described imaging device, there is a problem that the area of the optical unit when viewed from the optical axis direction increases by the amount of the flexible printed circuit board, and the size of the imaging device on which the unit is mounted increases.

The present technology has been made in view of such a situation, and an object thereof is to downsize an imaging device that performs rotation correction.

### Solutions to Problems

The present technology has been made to solve the above-described problem, and a first aspect of the present technology is a camera module including: a lens group; a translation actuator that translates the lens group; a rotary actuator that rotates the lens group; a rigid-flexible substrate that is partially deformed following rotation of the lens group; and a mounting substrate in which the translation actuator is provided on one of both surfaces and the rigid-flexible substrate is provided on the other of the both surfaces. Therefore, there is an effect of downsizing the camera module.

Furthermore, in the first aspect, the rotary actuator may include a shape memory alloy. Therefore, there is an effect of increasing the driving force of the rotary actuator.

Furthermore, in the first aspect, the rigid-flexible substrate may include: an outer frame that surrounds the mounting substrate; an inner frame that is connected to the mounting substrate; and a spring component that connects the outer frame and the inner frame. Therefore, there is an effect that the thickness of the camera module hardly changes.

Furthermore, in the first aspect, the mounting substrate may include an organic substrate. Therefore, there is an effect of downsizing the camera module in which the organic substrate is used.

Furthermore, in the first aspect, a semiconductor chip that is flip-chip mounted on the organic substrate may be further included. Therefore, there is an effect of downsizing the camera module in which the semiconductor chip is flip-chip mounted.

Furthermore, in the first aspect, a semiconductor chip that is mounted on the organic substrate by wire bonding may be further included. Therefore, there is an effect that a through hole is unnecessary in the organic substrate.

Furthermore, in the first aspect, a chip size package (CSP) that is connected to the mounting substrate may be further included. Therefore, there is an effect of downsizing the camera module in which the CSP is used.

Furthermore, in the first aspect, the mounting substrate may include a ceramic substrate. Therefore, there is an effect of improving performance of the camera module.

Furthermore, in the first aspect, the mounting substrate may include a hybrid substrate in which an organic substrate and a ceramic substrate are stacked. Therefore, there is an effect of improving performance of the camera module.

Furthermore, in the first aspect, the translation actuator may translate the lens group along at least one of three axes orthogonal to each other. Therefore, there is an effect that the position of the lens group is corrected in the directions of three axes.

Furthermore, in the first aspect, the rotary actuator may rotate the lens group about at least one of three axes orthogonal to each other. Therefore, there is an effect that the position of the lens group is corrected in the rotation directions.

Furthermore, a second aspect of the present technology is an imaging device including: a lens group; a translation actuator that translates the lens group; a rotary actuator that rotates the lens group; a rigid-flexible substrate that is partially deformed following rotation of the lens group; a mounting substrate in which the translation actuator is provided on one of both surfaces and the rigid-flexible substrate is provided on the other of the both surfaces; and a semiconductor chip that photoelectrically converts incident light from the lens group to generate image data. Therefore, there is an effect of downsizing the imaging device.

### BRIEF DESCRIPTION OF DRAWINGS

FIG. 1 is a block diagram depicting a configuration example of an imaging device according to a first embodiment of the present technology.

FIG. 2 is a block diagram depicting a configuration example of an optical unit according to the first embodiment of the present technology.

FIG. 3 is an example of a cross-sectional view of the optical unit according to the first embodiment of the present technology.

FIG. 4 is an example of a plan view of a flexible substrate before deformation according to the first embodiment of the present technology.

FIG. 5 is an example of an enlarged view of a spring component according to the first embodiment of the present technology.

FIG. 6 is an example of a plan view of the flexible substrate after deformation according to the first embodiment of the present technology.

FIG. 7 is an example of a cross-sectional view of an optical unit according to a second embodiment of the present technology.

FIG. 8 is an example of a cross-sectional view of an optical unit according to a third embodiment of the present technology.

FIG. 9 is an example of a cross-sectional view of an optical unit according to a fourth embodiment of the present technology.

FIG. 10 is examples of cross-sectional views of an optical unit and a chip size package (CSP) according to a fifth embodiment of the present technology.

FIG. 11 is a block diagram depicting a schematic configuration example of a vehicle control system.

FIG. 12 is an explanatory diagram depicting an example of an installation position of an imaging section.

### MODE FOR CARRYING OUT THE INVENTION

Hereinafter, modes for carrying out the present technology (hereinafter referred to as embodiments) will be described. The description will be given in the following order.
1. First embodiment (Example in which translation actuator, organic substrate, and rigid-flexible substrate are stacked)
2. Second embodiment (Example in which translation actuator, ceramic substrate, and rigid-flexible substrate are stacked)
3. Third embodiment (Example in which translation actuator, hybrid substrate, and rigid-flexible substrate are stacked)
4. Fourth embodiment (Example in which translation actuator, organic substrate, and rigid-flexible substrate are stacked and wire bonding is performed)
5. Fifth embodiment (Example in which translation actuator, organic substrate, and rigid-flexible substrate are stacked and CSP is mounted)
6. Application Example to Mobile Object

### 1. First Embodiment

### [Configuration Example of Imaging Device]

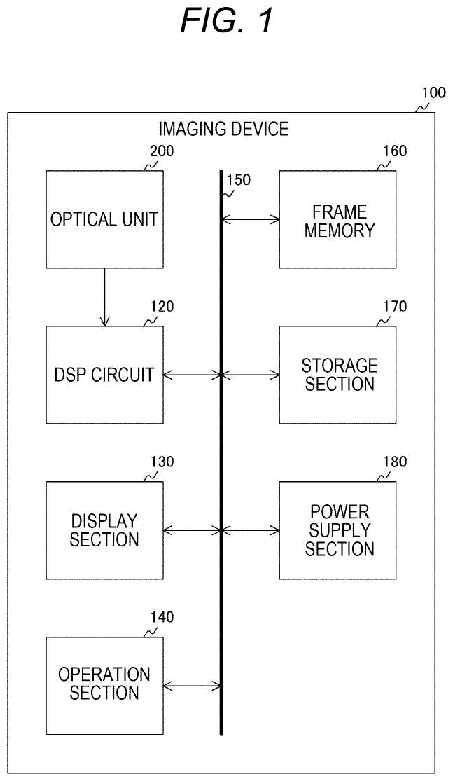

FIG. 1 is a block diagram depicting a configuration example of an imaging device 100 according to an embodiment of the present technology. The imaging device 100 is a device for capturing image data, and includes an optical unit 200. The imaging device 100 further includes a digital signal processing (DSP) circuit 120, a display section 130, an operation section 140, a bus 150, a frame memory 160, a storage section 170, and a power supply section 180. As the imaging device 100, for example, a small device such as a smartphone is assumed. Note that the imaging device 100 may be a digital camera such as a digital still camera, an in-vehicle camera, or the like.

The optical unit 200 generates image data by photoelectric conversion. The optical unit 200 supplies the generated image data to the DSP circuit 120.

The DSP circuit 120 executes predetermined signal processing on the image data from the optical unit 200. The DSP circuit 120 outputs the processed image data to the frame memory 160 or the like via the bus 150. Note that the DSP circuit 120 can also be disposed in the optical unit 200.

The display section 130 displays the image data. The display section 130 is assumed to be, for example, a liquid crystal panel or an organic electro luminescence (EL) panel. The operation section 140 generates an operation signal in accordance with a user operation.

The bus 150 is a common path through which the DSP circuit 120, the display section 130, the operation section 140, the frame memory 160, the storage section 170, and the power supply section 180 exchange data with each other.

The frame memory 160 holds the image data. The storage section 170 stores various types of data such as the image data. The power supply section 180 supplies power to the optical unit 200, the DSP circuit 120, the display section 130, and the like.

### [Configuration Example of Optical Unit]

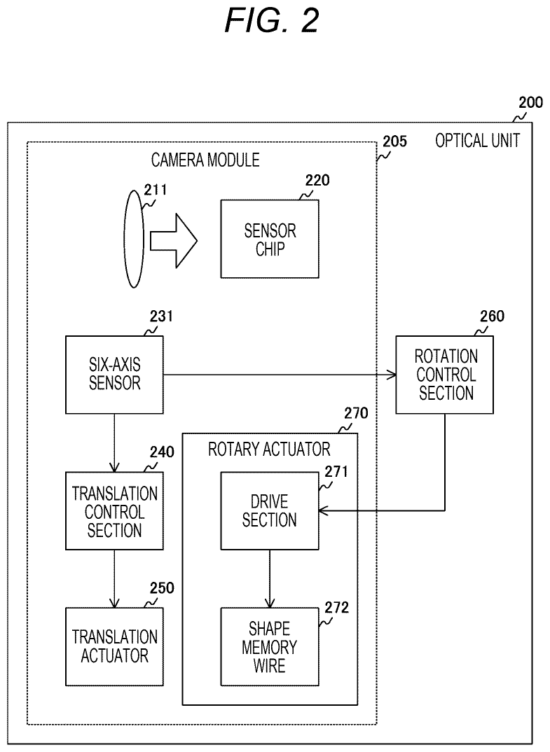

FIG. 2 is a block diagram depicting a configuration example of the optical unit 200 according to a first embodiment of the present technology. The optical unit 200 includes a camera module 205 and a rotation control section 260. In the camera module 205, a lens group 211, a sensor chip 220, a six-axis sensor 231, a translation control section 240, a translation actuator 250, and a rotary actuator 270 are arranged. Note that configurations other than these members are not depicted in the drawing.

The lens group 211 collects incident light and guides the light to the sensor chip 220. The lens group 211 includes one or more lenses.

The sensor chip 220 photoelectrically converts the incident light from the lens group 211 to generate image data. As the sensor chip 220, for example, a CMOS image sensor (CIS) or a charge coupled device (CCD) image sensor is used.

The six-axis sensor 231 measures accelerations in respective axial directions of three axes orthogonal to each other and angular velocities around the respective axes. As the six-axis sensor 231, for example, an inertial measurement unit (IMU) is used. The six-axis sensor 231 supplies the measurement values of the accelerations to the translation control section 240 and supplies the measurement values of the angular velocities to the rotation control section 260.

The translation control section 240 controls the translation actuator 250. On the basis of the measurement values of the six-axis sensor 231, the translation control section 240 calculates each of the correction amounts in three translation directions parallel to the three axes orthogonal to each other. Then, the translation control section 240 controls the translation actuator 250 by a control signal to translate the lens group 211 along at least one of the three axes by the correction amount. In a case where there is one direction in which the correction amount is other than “0”, the lens group 211 is translated only in that direction. In a case where there are two or three directions in which the correction amount is other than “0”, the lens group 211 is translated in the respective directions.

The translation actuator 250 translates the lens group 211 along at least one of the three axes under the control of the translation control section 240.

The rotation control section 260 controls the rotary actuator 270. On the basis of the measurement values of the six-axis sensor 231, the rotation control section 260 calculates each of the correction amounts in three rotation directions about the three axes orthogonal to each other. Then, the rotation control section 260 controls the rotary actuator 270 by a control signal to rotate the lens group 211 about at least one of the three axes by the correction amount.

The rotary actuator 270 rotates the lens group 211 about at least one of the three axes under the control of the rotation control section 260. As the rotary actuator 270, for example, a shape memory alloys (SMA) actuator is used. Furthermore, the rotary actuator 270 includes a drive section 271 and a shape memory wire 272. The shape memory wire 272 is a member on a wire including a shape memory alloy. The drive section 271 energizes and deforms the shape memory wire 272.

As illustrated in the drawing, six-axis correction can be realized in the camera module 205 by correction of the translation directions along the three axes and correction of the rotation directions about the three axes.

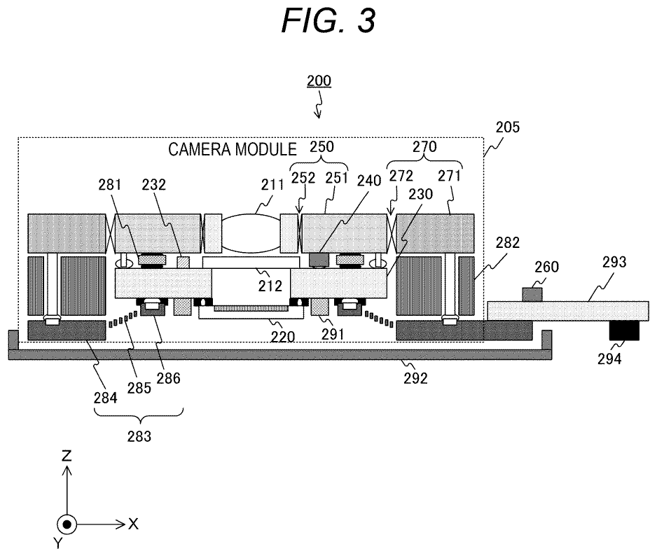

FIG. 3 is an example of a cross-sectional view of the optical unit 200 according to the first embodiment of the present technology. The camera module 205 is arranged in the optical unit 200. The camera module 205 includes the lens group 211, an IR cut filter (IRCF) 212, the sensor chip 220, and an organic substrate 230. Moreover, the camera module 205 includes the translation control section 240, the translation actuator 250, the drive section 271, a rigid-flexible substrate 283, a spacer 281, a spacer 282, and a fender 291. Furthermore, in the optical unit 200, a base 292, the rotation control section 260, a module flexible substrate 293, and a connector 294 are arranged outside the camera module 205.

Hereinafter, the optical axis of the lens group 211 is referred to as a “Z axis”. Furthermore, a predetermined axis perpendicular to the Z axis is defined as an “X axis”, and an axis perpendicular to the X axis and the Z axis is defined as a “Y axis”. Furthermore, in the Z-axis direction, the direction from the sensor chip 220 to the lens group 211 is defined as an “up” direction. The drawing is a cross-sectional view when viewed from the Y-axis direction.

The IRCF 212 removes an infrared light component of incident light from the lens group 211. Note that the IRCF 212 is arranged as necessary. Furthermore, an optical filter other than the IRCF 212 can be arranged.

The translation control section 240 and a predetermined number of solder-mounted components 232 are mounted on an upper surface of the organic substrate 230. As the solder-mounted component 232, for example, the above-described six-axis sensor 231 or the like is mounted. Furthermore, the translation actuator 250 is connected to the upper surface of the organic substrate 230 via the spacer 281. A side surface of the lens group 211 is attached to the translation actuator 250. Furthermore, the IRCF 212 is arranged immediately below the lens group 211 on the upper surface of the organic substrate 230.

Furthermore, in the organic substrate 230, a through hole penetrating the substrate is formed immediately below the lens group 211 and the IRCF 212. The sensor chip 220 is flip-chip mounted around the through hole on the lower surface of the organic substrate 230. A plurality of pixels is arranged on the upper surface of the sensor chip 220. Each pixel receives light incident through the lens group 211, the IRCF 212, and the through hole. Note that the sensor chip 220 is an example of a semiconductor chip described in the claims.

Furthermore, in addition to the sensor chip 220, the fender 291 and the extremely thin rigid-flexible substrate 283 are further provided on the lower surface of the organic substrate 230. The rigid-flexible substrate 283 includes an outer frame 284, a spring component 285, and an inner frame 286. The inner frame 286 is a frame-shaped rigid substrate, and the outer periphery of the frame is smaller than the outer periphery of the organic substrate 230 when viewed from the Z-axis direction. The inner frame 286 is attached to the lower surface of the organic substrate 230. The outer frame 284 is a frame-shaped rigid substrate, and the inner periphery of the frame is larger than the outer periphery of the organic substrate 230 when viewed from the Z-axis direction. The outer frame 284 surrounds the organic substrate 230, and the drive section 271 is electrically connected to the upper surface of the outer frame 284 via the spacer 282. The spring component 274 is a flexible member that connects the inner frame 2286 and the outer frame 284. Furthermore, the outer frame 284 is disposed in the base 292. Furthermore, the rigid-flexible substrate 283 is a conductive substrate, and the organic substrate 230 and the actuator can transmit signals via the rigid-flexible substrate 283.

Note that the organic substrate 230 is an example of a mounting substrate described in the claims. Furthermore, the number of organic substrates 230 is not limited to one, and a plurality of stacked organic substrates can also be used.

One end of the module flexible substrate 293 is connected to the outer frame 284 of the rigid-flexible substrate 283, and the other end is drawn out to the outside of the base 292. Furthermore, the module flexible substrate 293 is provided with the rotation control section 260 and the connector 294. The connector 294 is disposed outside the base 292. The captured image data is output to the outside via the connector 294.

As illustrated in the drawing, by disposing the translation control section 240 on the upper surface of the organic substrate 230 and disposing the rotation control section 260 on the module flexible substrate 293, the transmission distance between each of the control sections and the corresponding actuator can be minimized. Thus, power loss can be reduced.

The translation actuator 250 is electrically connected to the organic substrate 230, and translates the lens group 211 along at least one of the X axis, the Y axis, and the Z axis under the control of the translation control section 240 on the substrate. The drive actuator 250 includes a shape memory wire 252 and a drive section 251 that deforms the shape memory wire 252. Furthermore, in the rotary actuator 270, the shape memory wire 272 is deformed by power supply from the drive section 271, and rotates the lens group 211 about at least one of the X axis, the Y axis, and the Z axis. If the upward direction is a forward direction, one of the X axis and the Y axis corresponds to the pitch axis and the other corresponds to the yaw axis among the three rotation axes. The Z axis (that is, the optical axis) corresponds to the roll axis. Since the spring component 285 of the rigid-flexible substrate 283 is deformed following the rotation, the rotary actuator 270 on the outside can rotate the lens group 211 by using the outer frame 284 of the rigid-flexible substrate 283 as a base.

Here, a configuration in which the rigid-flexible substrate 283 is put outside the camera module 205 and disposed adjacent to the camera module 205 as viewed from the Z-axis direction is assumed as a comparative example. In this comparative example, six-axis correction cannot be realized by the camera module 205 alone, the area of the optical unit 200 when viewed from the Z-axis direction increases by the amount of the flexible substrate, and it becomes difficult to downsize the imaging device 100.

On the other hand, in the camera module 205 in the drawing, the rigid-flexible substrate 283 is arranged therein. Specifically, the translation actuator 250 is provided on the upper surface of the organic substrate 230, and the rigid-flexible substrate 283 is provided on the lower surface of the organic substrate 230. In other words, the translation actuator 250, the organic substrate 230, and the rigid-flexible substrate 283 are stacked. As a result, six-axis correction can be realized by the camera module 205 alone, and the area when viewed from the Z-axis direction is smaller than that of the comparative example. Furthermore, since the rigid-flexible substrate 283 is extremely thin, the thickness of the camera module 205 hardly changes. Therefore, the camera module 205, the optical unit 200, and the imaging device 100 can be downsized.

### [Configuration Example of Rigid-Flexible Substrate]

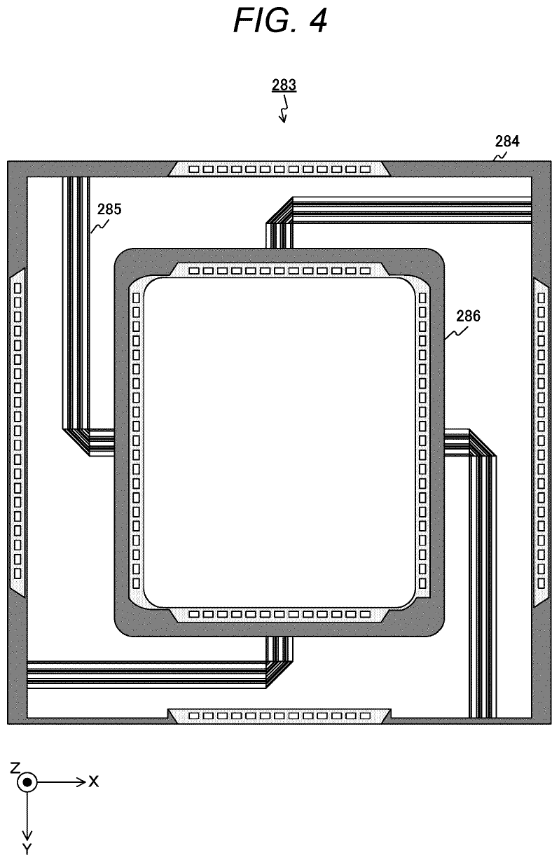

FIG. 4 is an example of a plan view of the rigid-flexible substrate 283 before deformation according to the first embodiment of the present technology. This drawing is an example of the rigid-flexible substrate 283 viewed from the Z-axis direction. As illustrated in the drawing, inside the outer frame 284, the inner frame 286 having a smaller size is disposed. The inner frame 286 is connected to the lower surface of the organic substrate 230. Furthermore, the outer frame 284 and the inner frame 286 are connected by the four spring components 285.

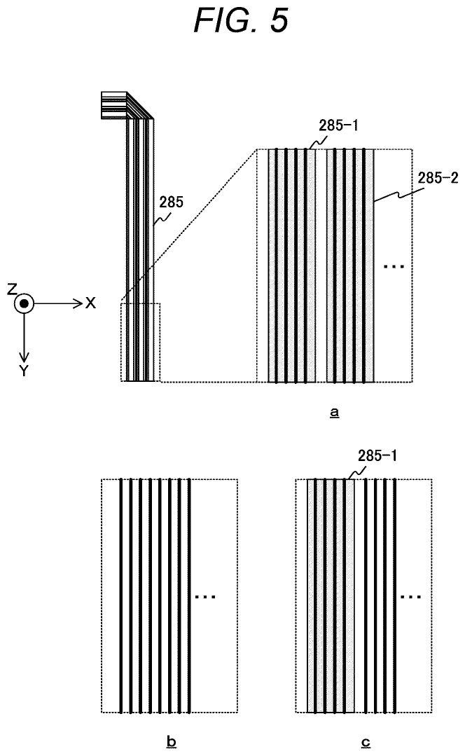

FIG. 5 is an example of an enlarged view of the spring component 285 according to the first embodiment of the present technology. For example, as exemplified in a of the drawing, the spring component 285 includes a plurality of harnesses such as harnesses 285-1 and 285-2. Each of the harnesses is a bundle of a plurality of wires.

Alternatively, as illustrated in b of the drawing, a plurality of independent wires may be wired in the spring component 285.

Alternatively, as illustrated in c of the drawing, the harness and independent wires may be mixed in the spring component 285.

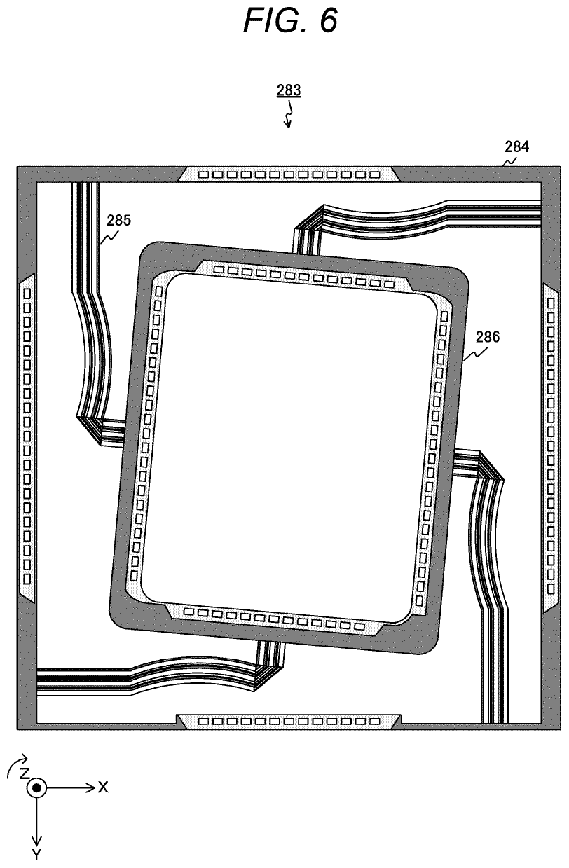

FIG. 6 is an example of a plan view of the rigid-flexible substrate 285 after deformation according to the first embodiment of the present technology. As illustrated in the drawing, the spring component 285 is deformed following rotation by the rotary actuator 270, and the inner frame 286 rotates about the Z axis (roll axis). Similarly, the spring component 285 can also deform following rotation about the X axis or the Y axis (pitch axis or yaw axis). The maximum angle of rotation rotatable about each of the X, Y, and Z axes is, for example, 10 degrees on each axis.

A voice coil motor (VCM) actuator can also be used to drive the lens group 211, but the weight that can be driven by the VCM actuator is limited, and a lens or the like corresponding to a 1-inch sensor or a larger sensor cannot be moved in some cases. By using an SMA actuator, a lens of 10 grams or more can be driven, and a lens of a size corresponding to a 1-inch sensor or a larger sensor can also be driven. Furthermore, in a case where the SMA actuator is used, not only a plastic lens but also a glass lens can be used because the driving force is large.

As described above, according to the first embodiment of the present technology, since the translation actuator 250 is provided on the upper surface of the organic substrate 230 and the rigid-flexible substrate 283 is provided on the lower surface of the organic substrate 230, the area of the camera module 205 can be reduced, and the imaging device 100 can be downsized.

### 2. Second Embodiment

In the above-described first embodiment, the organic substrate 230 is used as a substrate on which the sensor chip 220 and the like are mounted, but the mounting substrate is not limited to the organic substrate 230. An optical unit 200 in a second embodiment is different from that in the first embodiment in that the optical unit 200 is mounted on a ceramic substrate.

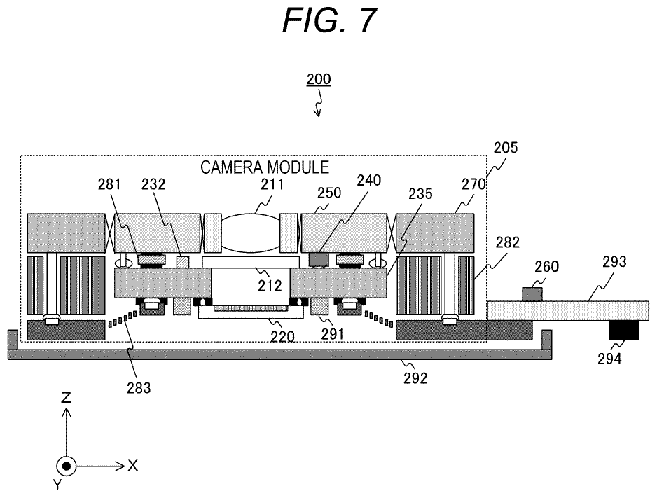

FIG. 7 is an example of a cross-sectional view of the optical unit 200 according to the second embodiment of the present technology. The optical unit 200 according to the second embodiment is different from that in the first embodiment in including a ceramic substrate 235 instead of the organic substrate 230. A sensor chip 220 is flip-chip mounted on the ceramic substrate 235 similarly in the first embodiment.

Note that the number of ceramic substrates 235 is not limited to one, and a plurality of stacked ceramic substrates can also be used.

Since the ceramic substrate 235 has excellent characteristics such as high thermal conductivity, low thermal expansion coefficient, low dielectric constant, and chemical resistance, the performance of a camera module 205 can be improved by using such a substrate.

As described above, according to the second embodiment of the present technology, since the ceramic substrate 235 is used, the performance of the camera module can be improved.

### 3. Third Embodiment

In the above-described first embodiment, the organic substrate 230 is used as a substrate on which the sensor chip 220 and the like are mounted, but the mounting substrate is not limited to the organic substrate 230. An optical unit 200 in a third embodiment is different from that in the first embodiment in that the optical unit 200 is mounted on a hybrid substrate.

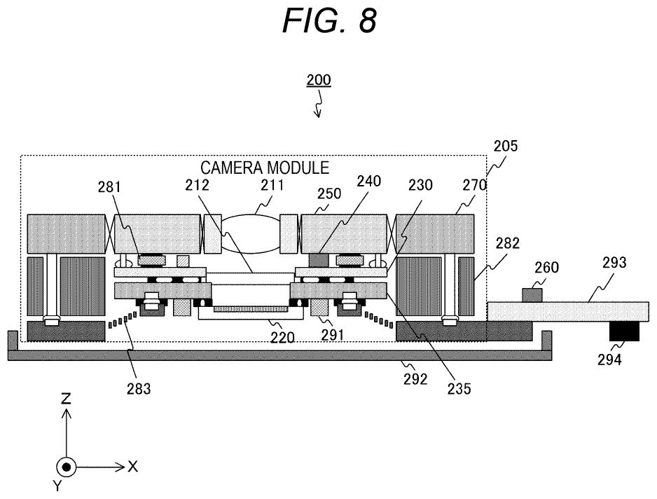

FIG. 8 is an example of a cross-sectional view of the optical unit 200 according to the third embodiment of the present technology. The optical unit 200 according to the third embodiment is different from that in the first embodiment in including a hybrid substrate instead of the organic substrate 230. In the hybrid substrate, an organic substrate 230 and a ceramic substrate 235 are stacked. Similarly in the first embodiment, a sensor chip 220 is flip-chip mounted on the ceramic substrate 235 of the hybrid substrate.

As described above, according to the third embodiment of the present technology, since the hybrid substrate is used, the performance of a camera module 205 can be improved.

### 4. Fourth Embodiment

In the first embodiment described above, the sensor chip 220 is flip-chip mounted, but the chip can also be mounted by wire bonding. An optical unit 200 according to a fourth embodiment is different from that in the first embodiment in that a sensor chip 220 is connected by wire bonding.

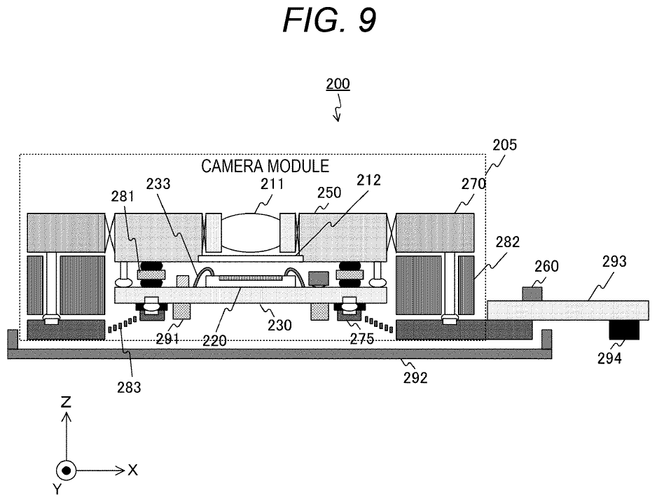

FIG. 9 is an example of a cross-sectional view of the optical unit 200 according to the fourth embodiment of the present technology. The optical unit 200 according to the fourth embodiment is different from that in the first embodiment in that a sensor chip 220 is electrically connected to an upper surface of an organic substrate 230 by a wire 233. Furthermore, it is not necessary to provide a through hole in the organic substrate 230 of the fourth embodiment.

As described above, according to the fourth embodiment of the present technology, since the sensor chip 220 is connected by wire bonding, it is not necessary to provide a through hole in the organic substrate 230.

### 5. Fifth Embodiment

In the above-described first embodiment, the sensor chip 220 is mounted on the organic substrate 230, but a CSP can be mounted instead. An optical unit 200 according to a fifth embodiment is different from that in the first embodiment in that a CSP is mounted.

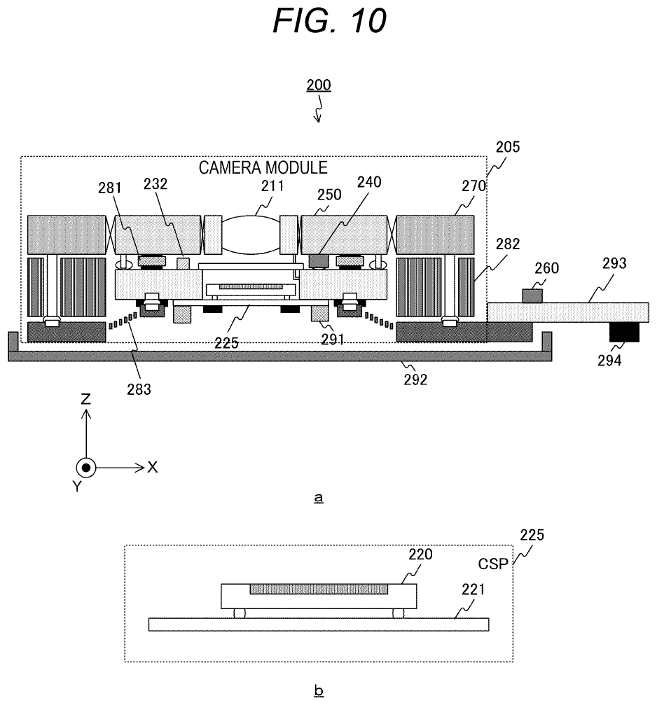

FIG. 10 is examples of cross-sectional views of the optical unit 200 and a CSP 225 according to the fifth embodiment of the present technology. In the drawing, a illustrates the cross-sectional view of the optical unit 200, and b illustrates the cross-sectional view of the CSP 225.

As illustrated in a of the drawing, the optical unit 200 in the fifth embodiment is different from that in the first embodiment in that the CSP 225 is mounted on a lower surface of an organic substrate 230. As illustrated in b of the drawing, the CSP 225 includes a sensor chip 220 and a conductive substrate 221. The sensor chip 220 and the organic substrate 230 are electrically connected via the conductive substrate 221.

As described above, according to the fifth embodiment of the present technology, a camera module 205 on which the CSP 225 is mounted can be downsized.

### 6. Application Example to Mobile Object

The technology according to the present disclosure (present technology) can be applied to various products. For example, the technology of the present disclosure may be achieved in the form of a device to be mounted on a mobile object of any kind, such as an automobile, an electric vehicle, a hybrid electric vehicle, a motorcycle, a bicycle, a personal mobility, an airplane, a drone, a vessel, or a robot.

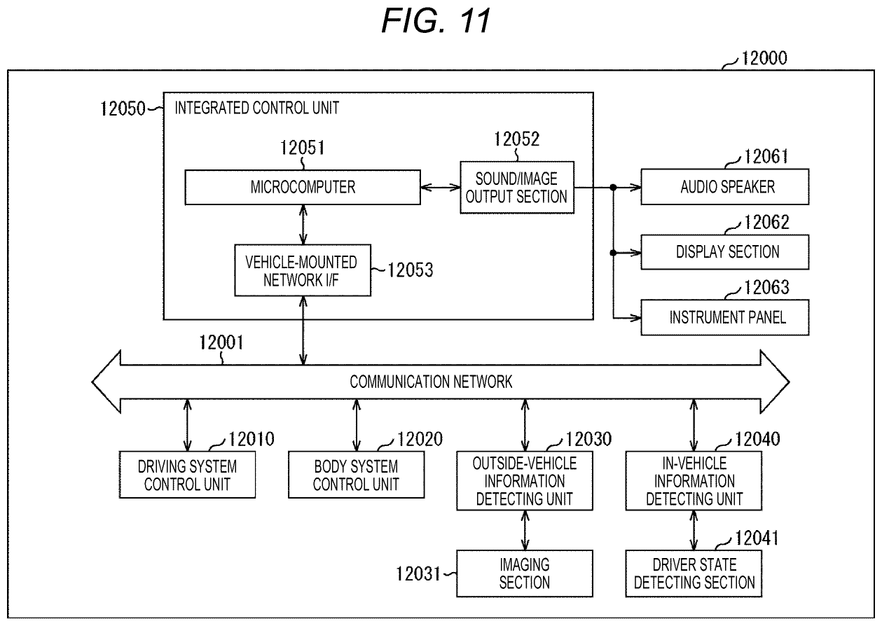

FIG. 11 is a block diagram depicting an example of schematic configuration of a vehicle control system as an example of a mobile object control system to which the technology according to the present disclosure can be applied.

The vehicle control system 12000 includes a plurality of electronic control units connected to each other via a communication network 12001. In the example illustrated in FIG. 11, the vehicle control system 12000 includes a driving system control unit 12010, a body system control unit 12020, an outside-vehicle information detecting unit 12030, an in-vehicle information detecting unit 12040, and an integrated control unit 12050. Furthermore, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

Furthermore, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 11, an audio speaker 12061, a display section 12062, and an instrument panel 12063 are illustrated as the output device. The display section 12062 may, for example, include at least one of an on-board display and a head-up display.

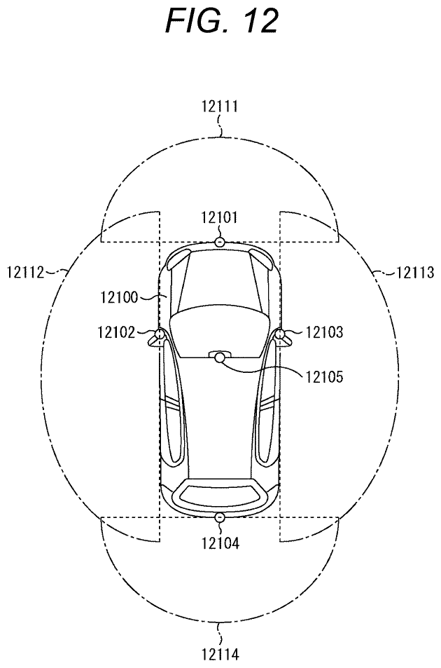

FIG. 12 is a diagram depicting an example of the installation position of the imaging section 12031.

In FIG. 12, the imaging section 12031 includes imaging sections 12101, 12102, 12103, 12104, and 12105.

The imaging sections 12101, 12102, 12103, 12104, 12105 are provided, for example, at positions such as a front nose, a sideview mirror, a rear bumper, a back door, and an upper portion of a windshield in the interior of a vehicle 12100. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly images of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 12 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure is applicable to the imaging section 12031, for example, among the configurations described above. Specifically, the imaging device 100 in FIG. 1 can be applied to the imaging section 12031. Since the size of the imaging section 12031 can be reduced by applying the technology according to the present disclosure to the imaging section 12031, a space for mounting the imaging section 12031 can be provided with a margin.

Note that the embodiments described above illustrate examples for embodying the present technology, and the matters in the embodiments and the matters specifying the invention in the claims have correspondence relationships. Similarly, the matters specifying the invention in the claims and matters with the same names in the embodiments of the present technology have correspondence relationships. However, the present technology is not limited to the embodiments, and can be embodied by applying various modifications to the embodiments without departing from the scope of the present technology.

Note that effects described in the present specification are merely examples and are not limited, and there may also be other effects.

Note that the present technology may also have the following configurations.

(1) A camera module including:
a lens group;
a translation actuator that translates the lens group;
a rotary actuator that rotates the lens group;
a rigid-flexible substrate that is partially deformed following rotation of the lens group; and
a mounting substrate in which the translation actuator is provided on one of both surfaces and the rigid-flexible substrate is provided on the other of the both surfaces.

(2) The camera module according to (1), in which the rotary actuator includes a shape memory alloy.

(3) The camera module according to (2), in which the rigid-flexible substrate includes:
an outer frame that surrounds the mounting substrate;
an inner frame that is connected to the mounting substrate; and
a spring component that connects the outer frame and the inner frame.

(4) The camera module according to any one of (1) to (3),
in which the mounting substrate includes an organic substrate.

(5) the camera module according to (4) further including:
a semiconductor chip that is flip-chip mounted on the organic substrate.

(6) The camera module according to (4) further including:
a semiconductor chip that is mounted on the organic substrate by wire bonding.

(7) The camera module according to (1) further including:
a chip size package (CSP) that is connected to the mounting substrate.

(8) The camera module according to (1),
in which the mounting substrate includes a ceramic substrate.

(9) The camera module according to (1),
in which the mounting substrate includes a hybrid substrate in which an organic substrate and a ceramic substrate are stacked.

(10) The camera module according to any one of (1) to (9),
in which the translation actuator translates the lens group along at least one of three axes orthogonal to each other.

(11) The camera module according to any one of (1) to (10),
in which the rotary actuator rotates the lens group about at least one of three axes orthogonal to each other.

(12) An imaging device including:
a lens group;
a translation actuator that translates the lens group;
a rotary actuator that rotates the lens group;
a rigid-flexible substrate that is partially deformed following rotation of the lens group;
a mounting substrate in which the translation actuator is provided on one of both surfaces and the rigid-flexible substrate is provided on the other of the both surfaces; and
a semiconductor chip that photoelectrically converts incident light from the lens group to generate image data.

### REFERENCE SIGNS LIST

100 Imaging device
120 DSP circuit
130 Display section
140 Operation section
150 Bus
160 Frame memory
170 Storage section
180 Power supply section
200 Optical unit
205 Camera module
211 Lens group
212 IRCF
220 Sensor chip
221 Conductive substrate
225 CSP
230 Organic substrate
231 Six-axis sensor
232 Solder-mounted component
233 Wire
235 Ceramic substrate
240 Translation control section
250 Translation actuator
251, 271 Drive section
252, 272 Shape memory wire
260 Rotation control section
270 Rotary actuator
281, 282 Spacer
283 Rigid-flexible substrate
284 Outer frame
285 Spring component
285-1, 285-2 Harness
286 Inner frame
291 Fender
292 Base
293 Module flexible substrate
294 Connector
12031 Imaging section

1. A camera module comprising:
a lens group;
a translation actuator that translates the lens group;
a rotary actuator that rotates the lens group;
a rigid-flexible substrate that is partially deformed following rotation of the lens group; and
a mounting substrate in which the translation actuator is provided on one of both surfaces and the rigid-flexible substrate is provided on another of the both surfaces.

2. The camera module according to claim 1,
wherein the rotary actuator includes a shape memory alloy.

3. The camera module according to claim 2,
wherein the rigid-flexible substrate includes:
an outer frame that surrounds the mounting substrate;
an inner frame that is connected to the mounting substrate; and
a spring component that connects the outer frame and the inner frame.

4. The camera module according to claim 1,
wherein the mounting substrate includes an organic substrate.

5. The camera module according to claim 4 further comprising:
a semiconductor chip that is flip-chip mounted on the organic substrate.

6. The camera module according to claim 4 further comprising:
a semiconductor chip that is mounted on the organic substrate by wire bonding.

7. The camera module according to claim 4 further comprising:
a chip size package (CSP) that is connected to the mounting substrate.

8. The camera module according to claim 1,
wherein the mounting substrate includes a ceramic substrate.

9. The camera module according to claim 1,
wherein the mounting substrate includes a hybrid substrate in which an organic substrate and a ceramic substrate are stacked.

10. The camera module according to claim 1,
wherein the translation actuator translates the lens group along at least one of three axes orthogonal to each other.

11. The camera module according to claim 1,
wherein the rotary actuator rotates the lens group about at least one of three axes orthogonal to each other.

12. An imaging device comprising:
a lens group;
a translation actuator that translates the lens group;
a rotary actuator that rotates the lens group;
a rigid-flexible substrate that is partially deformed following rotation of the lens group;
a mounting substrate in which the translation actuator is provided on one of both surfaces and the rigid-flexible substrate is provided on another of the both surfaces; and
a semiconductor chip that photoelectrically converts incident light from the lens group to generate image data.
